(19) United States
(12) Patent Application Publication
(10) Pub. No.: US 2026/0206905 A1
(43) Pub. Date: Jul. 23, 2026

(54) ADJUSTABLE HINGE MOUNT

(71) Applicant: ArmorSource, LLC, Hebron, OH (US)

(72) Inventor: Frank W. Green, Mount Vernon, OH (US)

(21) Appl. No.: 19/455,237

(22) Filed: Jan. 21, 2026

Related U.S. Application Data
(60) Provisional application No. 63/747,345, filed on Jan. 21, 2025.

(51) Int. Cl. A42B 3/30; F16M 11/10

(52) U.S. Cl. CPC A42B 3/30; F16M 11/10

(57) ABSTRACT

An adjustable hinge mount for positioning an attachment device on a helmet includes a first mounting interface configured to connect with a helmet and a second mounting interface configured to connect with the attachment device, a hinge connecting the first mounting interface with the second mounting interface and providing a pivot axis therebetween, and an adjustment mechanism configured to rotate the second mounting interface relative to the first mounting interface about the pivot axis. The adjustment mechanism includes a screw and a linear actuator, wherein rotation of the screw causes linear movement of the linear actuator to engage the second mounting interface and impart rotation about the pivot axis.

### CROSS-REFERENCE TO RELATED APPLICATIONS

This application claims priority to U.S. Application No. 63/747,345, titled Hinge Mount, filed Jan. 21, 2025, which is hereby incorporated by reference in its entirety.

### FIELD OF INVENTION

The present disclosure relates to mounting systems for helmet accessories, and more particularly to an adjustable hinge mount for positioning communications devices or hearing protection on helmets.

### BACKGROUND

Military and tactical helmets are commonly equipped with rail systems that allow attachment of various accessories, including communications headsets, hearing protection devices, night-vision equipment, and other operational gear. These rail systems, such as M-LOK and Wing-Loc configurations, provide standardized mounting interfaces along the sides of the helmet shell, enabling users to configure their helmets according to mission requirements or personal preferences.

Communications devices and hearing protection are frequently mounted to helmet rail systems to provide hands-free audio capabilities while maintaining head protection. These devices typically include ear cups or mufflers that are positioned over or against the wearer's ears and are connected to the helmet via mounting arms or adapters. Proper positioning of such devices against the wearer's head is desirable for both comfort during extended wear and effective noise attenuation or audio transmission.

Existing mounting solutions for helmet-attached communications devices and hearing protection generally employ adapter-type mounts that connect the rail interface to the device interface without providing angular adjustment between these two interfaces. The geometry of the connection between the helmet rail and the communications device is therefore fixed, which can result in suboptimal positioning of the ear cups relative to the wearer's head. Variations in helmet size, rail mounting angle, head shape, and device design can all contribute to fit issues when using fixed-geometry mounting adapters.

Some communications devices incorporate limited adjustability features within the arms that extend from the main housing to the mounting interface. However, this adjustability is often restricted to discrete positions, such as an open position for donning and doffing the helmet and a closed position for use. End users have attempted to customize the fit of their equipment by bending components or adding third-party adapters into the mounting system, though such modifications can be imprecise, may cause component damage, and can introduce additional points of failure or create snag hazards.

The relationship between the helmet rail angle and the communications device position affects both the comfort and the protective effectiveness of the hearing protection. Ear protection that does not seat properly against the wearer's head may provide reduced noise attenuation, while devices that press too tightly can cause discomfort during prolonged use. Accommodating the range of helmet configurations, rail angles, and head shapes encountered across different users and equipment combinations presents ongoing challenges in the design of helmet accessory mounting systems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure provides an adjustable hinge mount for positioning an attachment device on a helmet, the mount including a first mounting interface configured to connect with the helmet, a second mounting interface configured to connect with the attachment device, a hinge connecting the first mounting interface with the second mounting interface and providing a pivot axis therebetween, and an adjustment mechanism configured to rotate the second mounting interface relative to the first mounting interface about the pivot axis, wherein the adjustment mechanism includes a screw and a linear actuator, and rotation of the screw causes linear movement of the linear actuator to engage the second mounting interface and impart rotation about the pivot axis.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a first perspective view of a hinge mount in a closed configuration, according to aspects of the present disclosure.

FIG. 2 is a second perspective view of the hinge mount of FIG. 1, according to aspects of the present disclosure.

FIG. 3 is a side view of the hinge mount attached to a helmet having a rail system, according to aspects of the present disclosure.

FIG. 4 is a rear perspective view of the hinge mount attached to the helmet of FIG. 3, according to aspects of the present disclosure.

FIG. 5 is a first side view of the hinge mount, according to aspects of the present disclosure.

FIG. 6 is a second side view of the hinge mount of FIG. 5, according to aspects of the present disclosure.

FIG. 7 is a bottom plan view of the hinge mount, according to aspects of the present disclosure.

FIG. 8 is a top plan view of the hinge mount of FIG. 7, according to aspects of the present disclosure.

FIG. 9 is a rear elevation view of the hinge mount, according to aspects of the present disclosure.

FIG. 10 is a front elevation view of the hinge mount of FIG. 9, according to aspects of the present disclosure.

FIG. 11 is a perspective view of the hinge mount in an open, tilted configuration, according to aspects of the present disclosure.

FIG. 12 is a second perspective view of the hinge mount of FIG. 11 in the open, tilted configuration, according to aspects of the present disclosure.

FIG. 13 is a first side perspective view of the hinge mount in the open, tilted configuration, according to aspects of the present disclosure.

FIG. 14 is a second side perspective view of the hinge mount of FIG. 13, tilted configuration, according to aspects of the present disclosure.

FIG. 15 is a top plan view of the hinge mount showing interior sides of mounting interfaces, tilted configuration, according to aspects of the present disclosure.

FIG. 16 is a bottom plan view of the hinge mount of FIG. 15, tilted configuration, according to aspects of the present disclosure.

FIG. 17 is a front elevation view of the hinge mount showing a threaded attachment shaft, tilted configuration, according to aspects of the present disclosure.

FIG. 18 is a rear elevation view of the hinge mount of FIG. 17, tilted configuration, according to aspects of the present disclosure.

FIG. 19 is a rear elevation view of a first mounting interface, according to aspects of the present disclosure.

FIG. 20 is a front elevation view of the first mounting interface of FIG. 19, according to aspects of the present disclosure.

FIG. 21 is a front perspective view of the first mounting interface of FIG. 19, according to aspects of the present disclosure.

FIG. 22 is an exploded perspective view of the first mounting interface and associated components, according to aspects of the present disclosure.

FIG. 23 is a bottom exploded perspective view of the first mounting interface and a linear actuator mechanism, according to aspects of the present disclosure.

FIG. 24 is a front exploded perspective view of the first mounting interface with a linear actuator, according to aspects of the present disclosure.

FIG. 25 is a perspective view of a screw and linear actuator in an exploded configuration, according to aspects of the present disclosure.

FIG. 26 is a perspective view of the first mounting interface with a removable screw support bed, according to aspects of the present disclosure.

FIG. 27 is a first exploded perspective view of the hinge mount showing first and second mounting interfaces, according to aspects of the present disclosure.

FIG. 28 is a second exploded perspective view of the hinge mount of FIG. 27, according to aspects of the present disclosure.

FIG. 29 is a first perspective view of a second mounting interface showing pivot cams, according to aspects of the present disclosure.

FIG. 30 is a second perspective view of the second mounting interface of FIG. 29 with a linear actuator, according to aspects of the present disclosure.

FIG. 31 is a perspective view of a removable screw support bed, according to aspects of the present disclosure.

FIG. 32 is a perspective view of the removable screw support bed of FIG. 31 with a screw and linear actuator assembled therein, according to aspects of the present disclosure.

FIG. 33 is a perspective view of the removable screw support bed of FIG. 31 from a different perspective, according to aspects of the present disclosure.

FIG. 34 is a first exploded perspective view of the second mounting interface and the removable screw support bed, according to aspects of the present disclosure.

FIG. 35 is a second exploded perspective view of the second mounting interface of FIG. 34, according to aspects of the present disclosure.

FIG. 36 is a first perspective view of the hinge mount showing the linear actuator mechanism, according to aspects of the present disclosure.

FIG. 37 is a second perspective view of the first mounting interface of FIG. 36 without the second mounting interface, according to aspects of the present disclosure.

FIG. 38 is a perspective view of the second mounting interface showing pivot cams and the linear actuator, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

An adjustable hinge mount may be configured to position an attachment device on a helmet or a helmet with accessory attachment features, such as a rail interface.

The adjustable hinge mount may be configured to provide angular adjustment between a helmet rail interface and an attachment device, may provide angular adjustment when connected to an accessory mounting system on a helmet, or may provide angular adjustment when connected directly to a side surface of a helmet without utilizing a rail mounting system or accessory mounting system.

In some cases, the attachment device may be a communications headset. In some cases, the attachment device may be hearing protection. In some cases, the attachment device may be a combined communications headset and hearing protection device.

The adjustable hinge mount may address challenges associated with fitting hearing protection and communications devices to helmets equipped with rail systems, to helmets equipped with accessory mounting systems, or to helmets configured for direct mounting. Ear protection that is too loose may not provide full noise attenuation, while ear protection or communications devices that are too tight may be uncomfortable, particularly over extended use. The adjustable hinge mount may provide an infinitely adjustable fit to improve comfort and safety.

In some cases, the adjustable hinge mount may allow full interchangeability with different helmet manufacturers, rail manufacturers, and communications device manufacturers. The adjustable hinge mount may be configured to work with various rail mounting systems regardless of helmet size, type, or rail mounting angle. In some cases, the adjustable hinge mount may be configured to interface with accessory mounting systems on a helmet. In some cases, the adjustable hinge mount may be configured to connect directly to a helmet shell or side surface without requiring a rail mounting system or accessory mounting system.

The adjustable hinge mount may be adjusted while mounted to a helmet and communications device. In some cases, the adjustable hinge mount may be adjusted while an entire assembly including the helmet and communications device is worn on a head of a user. A pair of adjustable hinge mounts may be utilized, with each adjustable hinge mount attached to an opposing side of a helmet to independently support and adjust a pair of attachment devices or each side of a communications headset.

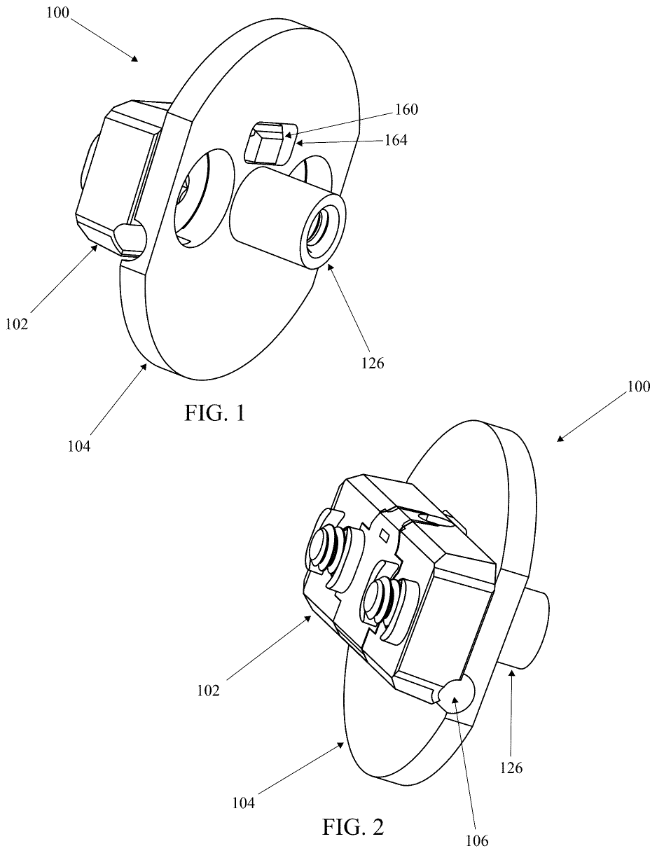

Referring to FIGS. 1 and 2, a hinge mount 100 may be configured for positioning an attachment device on a helmet having a rail mounting system, on a helmet having an accessory mounting system, or on a helmet configured for direct mounting. The hinge mount 100 may include a first mounting interface 102, a second mounting interface 104, and a hinge 106 connecting the first mounting interface 102 with the second mounting interface 104. The hinge 106 may provide a pivot axis between the first mounting interface 102 and the second mounting interface 104, allowing angular adjustment between the first mounting interface 102 and the second mounting interface 104.

The first mounting interface 102 may be configured to connect with the rail mounting system. In some cases, the first mounting interface 102 may be configured to interface with an accessory mounting system on a helmet. In some cases, the first mounting interface 102 may be configured to connect directly to a side surface of a helmet without utilizing a rail mounting system or accessory mounting system. The second mounting interface 104 may be configured to connect with the attachment device. A threaded attachment shaft 126 may extend perpendicularly outward from an exterior surface 128 of the second mounting interface 104. The threaded attachment shaft 126 may be configured to connect with the attachment device, such as a communications headset or hearing protection device.

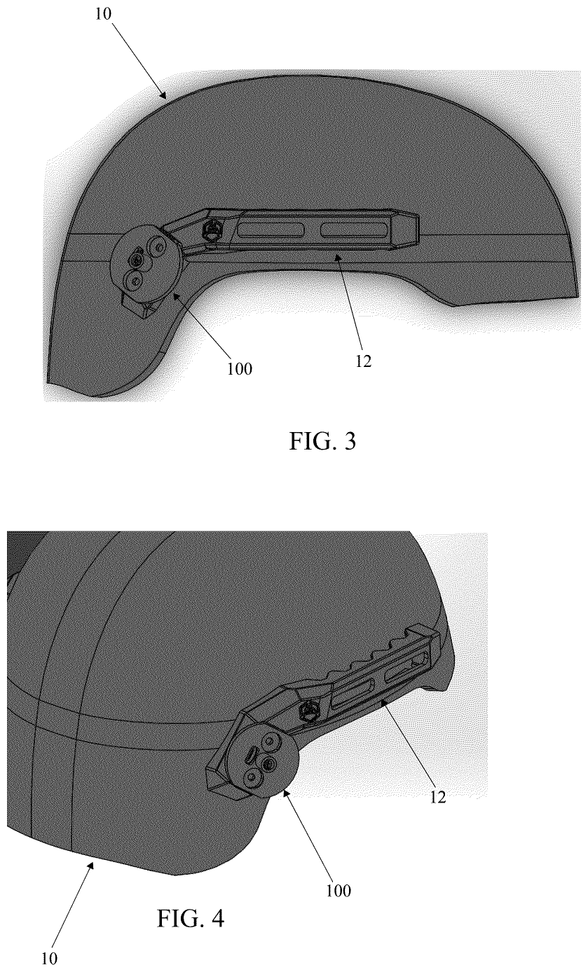

Referring to FIGS. 3 and 4, the hinge mount 100 may be attached to a helmet 10 having a rail system 12. The rail system 12 may extend along a side of the helmet 10, providing a mounting surface for the hinge mount 100. The first mounting interface 102 may interface with the rail system 12 to secure the hinge mount 100 to the helmet 10. In some cases, the first mounting interface 102 may include curved rail connection fittings configured to interface with the rail mounting system. In some cases, the hinge mount 100 may be attached to an accessory mounting system on the helmet 10. In some cases, the hinge mount 100 may be attached directly to a side surface of the helmet 10 without utilizing the rail system 12 or an accessory mounting system.

With continued reference to FIGS. 3 and 4, a pair of hinge mounts 100 may be utilized, with each hinge mount 100 attached to an opposing side of the helmet 10 via the rail system 12, via an accessory mounting system, or directly to the helmet shell. The hinge mount 100 may work with all rails of the same mounting system regardless of helmet size, type, or rail mounting angle. In some cases, the hinge mount 100 may be configured for attachment to an accessory mounting system on the helmet 10. In some cases, the hinge mount 100 may be configured for direct attachment to the helmet 10 without requiring a rail system or accessory mounting system.

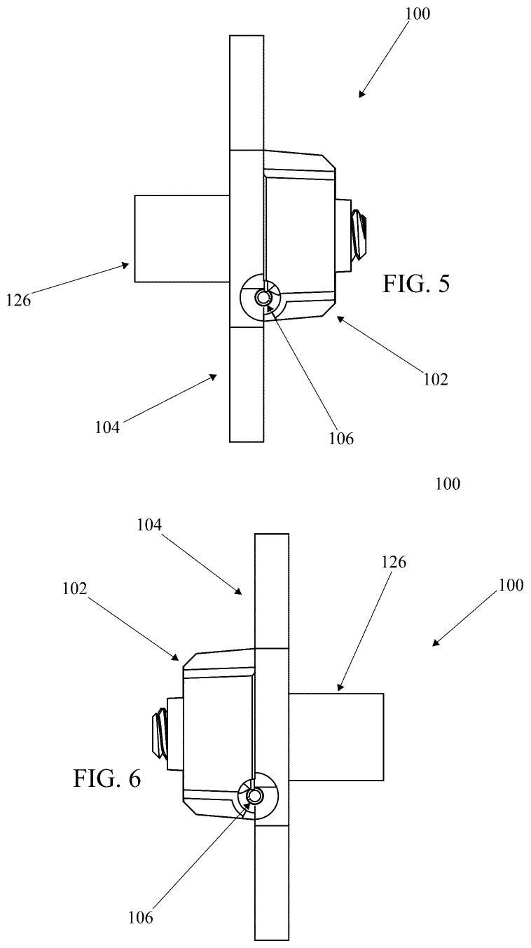

Referring to FIGS. 5 and 6, side views of the hinge mount 100 illustrate the relationship between the first mounting interface 102 and the second mounting interface 104. The hinge 106 connects the first mounting interface 102 with the second mounting interface 104 and provides the pivot axis that enables rotational adjustment between the two interfaces. The threaded attachment shaft 126 extends outward from the second mounting interface 104 and is positioned to connect with an attachment device. The hinge 106 may allow angular adjustment between respective interface planes of the first mounting interface 102 and the second mounting interface 104.

Further, the hinge mount 100 may be configured to add no notable extra bulk or snag hazard compared to non-adjustable mounts. The compact arrangement of the first mounting interface 102 and the second mounting interface 104 connected by the hinge 106 may provide adjustability while maintaining a low-profile configuration. The slot 164 may receive the shaped protrusion 160 in the closed configuration, contributing to a streamlined profile.

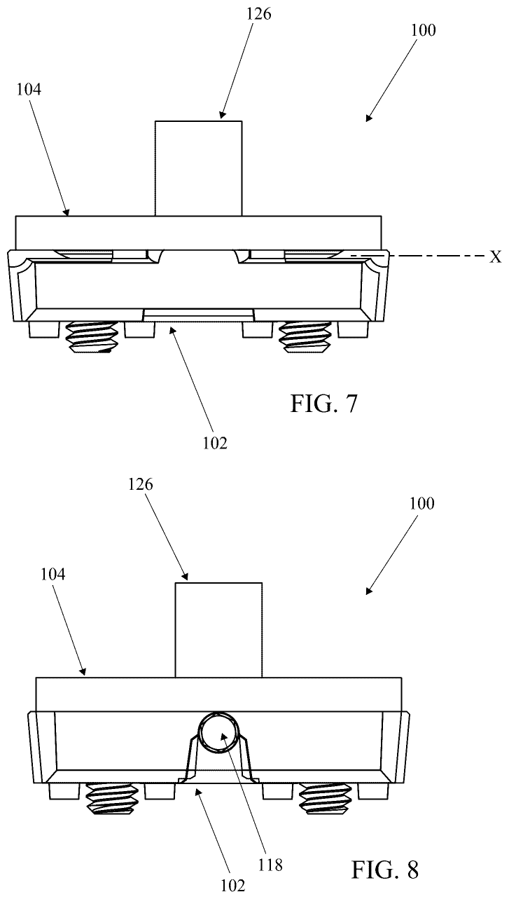

Referring to FIGS. 7 and 8, bottom and top views of the hinge mount 100 illustrate the relationship between the first mounting interface 102 and the second mounting interface 104 in a closed configuration. In FIG. 7, the hinge mount 100 is shown in a bottom plan view with the second mounting interface 104 positioned adjacent to the first mounting interface 102. The threaded attachment shaft 126 extends perpendicularly outward from the second mounting interface 104. A pivot axis X is indicated extending from the hinge 106 connection between the first mounting interface 102 and the second mounting interface 104.

With continued reference to FIG. 8, the hinge mount 100 is shown from a top plan view, displaying the first mounting interface 102 and the second mounting interface 104. An adjustment access port 118 is visible on the first mounting interface 102. The adjustment access port 118 may provide access to an actuator housing 114 positioned within the first mounting interface 102. In some cases, a head of a screw may include a drive aligned with the adjustment access port 118, allowing adjustment of an angular position between the first mounting interface 102 and the second mounting interface 104.

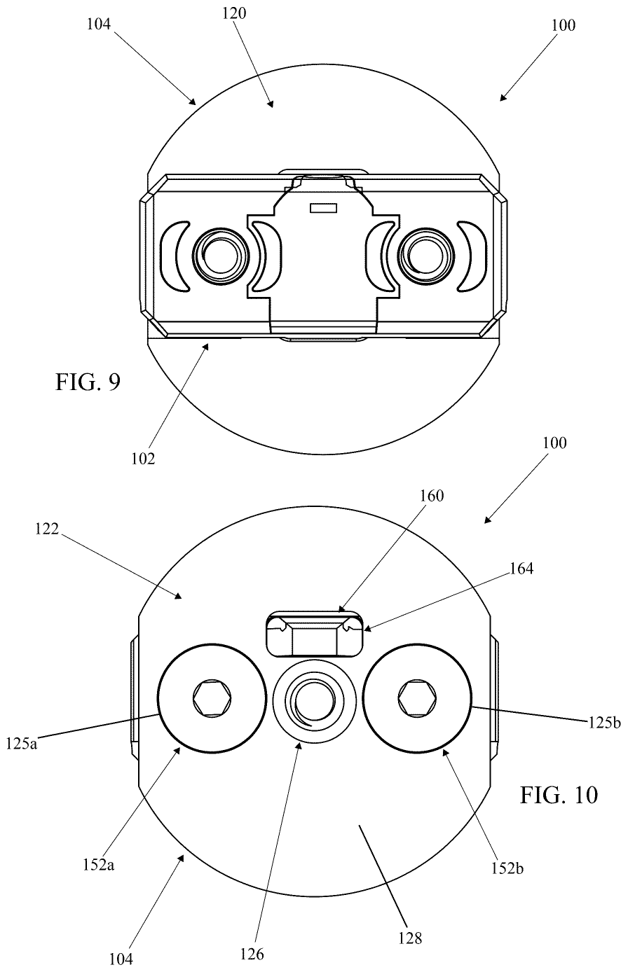

Referring to FIGS. 9 and 10, rear and front elevation views of the hinge mount 100 illustrate the positioning of components in the closed configuration. In FIG. 9, a rear elevation view shows the hinge mount 100 with the second mounting interface 104 positioned adjacent to the first mounting interface 102. In FIG. 10, a front elevation view shows the hinge mount 100 displaying the second mounting interface 104 with an exterior surface 128 visible. The threaded attachment shaft 126 extends outward from a center of the exterior surface 128.

With continued reference to FIG. 10, a first connection screw 152a and a second connection screw 152b are shown through a first screw access port 125a and a second screw access port 125b, respectively. The first screw access port 125a and the second screw access port 125b extend between an interior side 120 and an exterior side 122 of the second mounting interface 104. The first screw access port 125a and the second screw access port 125b may provide access for connection screws to attach the first mounting interface 102 to the rail mounting system, to an accessory mounting system, or directly to a helmet surface. The first connection screw 152a and the second connection screw 152b are positioned on either side of the threaded attachment shaft 126, providing attachment points for securing the hinge mount 100 to the rail system 12, to an accessory mounting system, or directly to the helmet 10.

As further shown in FIG. 10, a shaped protrusion 160 is visible through a slot 164 positioned above the threaded attachment shaft 126. The shaped protrusion 160 may extend from the first mounting interface 102 and may be received within the slot 164 of the second mounting interface 104 when the hinge mount 100 is in the closed configuration, thereby interlocking the first mounting interface 102 with the second mounting interface 104.

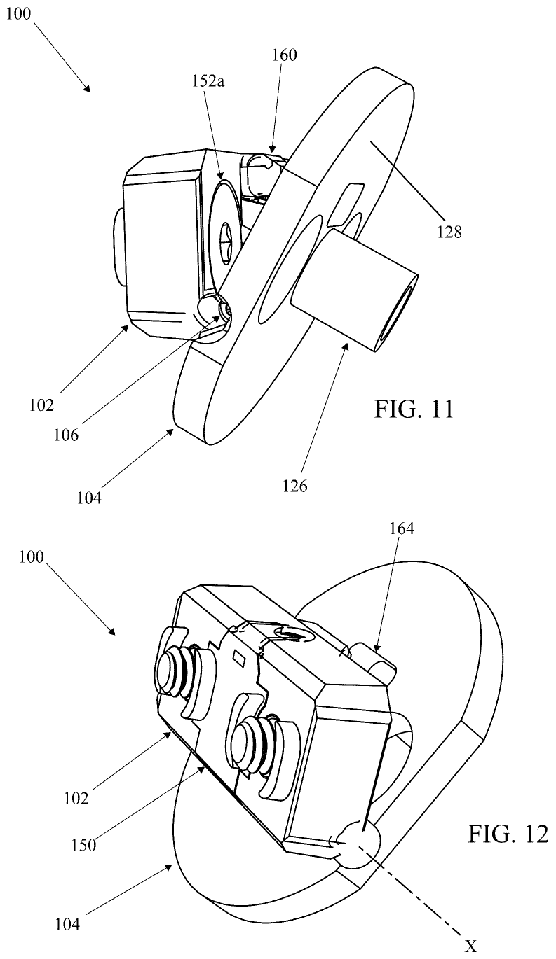

FIGS. 11 and 12, the hinge mount 100 is shown in an open, tilted configuration, illustrating the angular relationship between the first mounting interface 102 and the second mounting interface 104. The hinge 106 connects the first mounting interface 102 with the second mounting interface 104 and provides a pivot axis that enables rotational adjustment between the two interfaces. In the open, tilted configuration, the second mounting interface 104 is rotated relative to the first mounting interface 102 about the pivot axis.

The hinge 106 may provide rotation of the second mounting interface 104 relative to the first mounting interface 102 through a range of 0 degrees to 30 degrees. In some cases, the hinge 106 may allow up to 30 degrees or more of rotation between respective interface planes of the first mounting interface 102 and the second mounting interface 104. The hinge mount 100 may provide infinitely adjustable positioning between 0 degrees and 30 degrees, allowing for continuous adjustment rather than discrete positions.

With continued reference to FIG. 11, the first connection screw 152a is visible on the first mounting interface 102. The threaded attachment shaft 126 extends outward from the second mounting interface 104. The shaped protrusion 160 is shown extending forward from the first mounting interface 102, positioned outside of the slot 164 on the second mounting interface 104 when in the open, tilted configuration. The exterior surface 128 of the second mounting interface 104 is visible.

As further shown in FIG. 12, a removable screw support bed 150 is visible on a rear surface of the first mounting interface 102. The slot 164 is visible on the second mounting interface 104. A pivot axis X is indicated by a dashed line extending from the hinge 106 connection between the first mounting interface 102 and the second mounting interface 104.

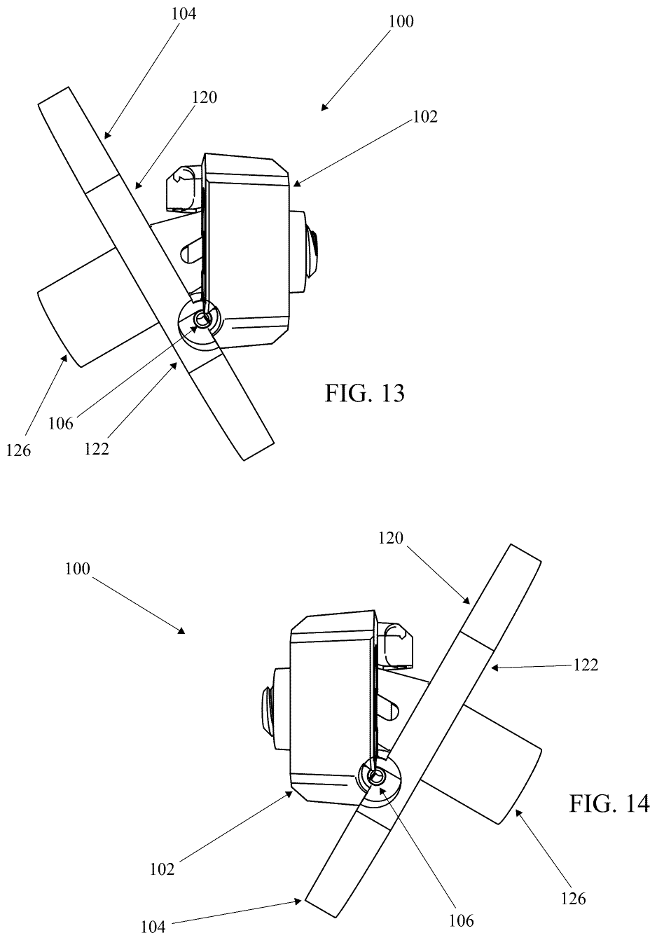

Referring to FIGS. 13 and 14, side perspective views of the hinge mount 100 in the open, tilted configuration illustrate the relationship between the first mounting interface 102 and the second mounting interface 104. The second mounting interface 104 includes an interior side 120 and an exterior side 122. The threaded attachment shaft 126 extends outward from the second mounting interface 104 and is configured to connect with an attachment device such as a communications headset or hearing protection device.

With continued reference to FIGS. 13 and 14, the hinge 106 connects the first mounting interface 102 with the second mounting interface 104 and allows rotational adjustment between the respective interface planes. The interior side 120 and the exterior side 122 of the second mounting interface 104 are visible, along with the threaded attachment shaft 126 extending perpendicularly outward from the exterior side 122.

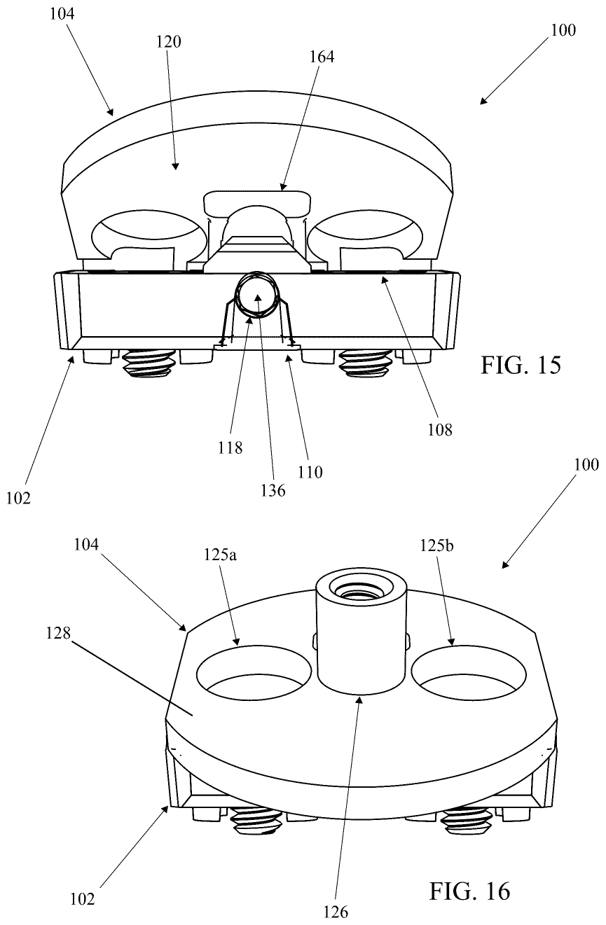

Referring to FIGS. 15 and 16, top and bottom plan views of the hinge mount 100 illustrate the relationship between the first mounting interface 102 and the second mounting interface 104. In FIG. 15, a top plan view shows the hinge mount 100 with the second mounting interface 104 positioned adjacent to the first mounting interface 102. The second mounting interface 104 includes the interior side 120 and displays the slot 164 positioned on an upper portion. The first mounting interface 102 includes an interior side 108 and an exterior side 110, with the adjustment access port 118 visible on the exterior side 110.

As further shown in FIG. 15, a screw 136 is shown positioned within the adjustment access port 118. The screw 136 generally allows adjustment of the angular position between the first mounting interface 102 and the second mounting interface 104.

With continued reference to FIG. 16, a bottom plan view shows the second mounting interface 104 with the exterior surface 128 visible. The threaded attachment shaft 126 extends perpendicularly outward from a center of the exterior surface 128. The first screw access port 125a and the second screw access port 125b are positioned on either side of the threaded attachment shaft 126, providing access through the second mounting interface 104.

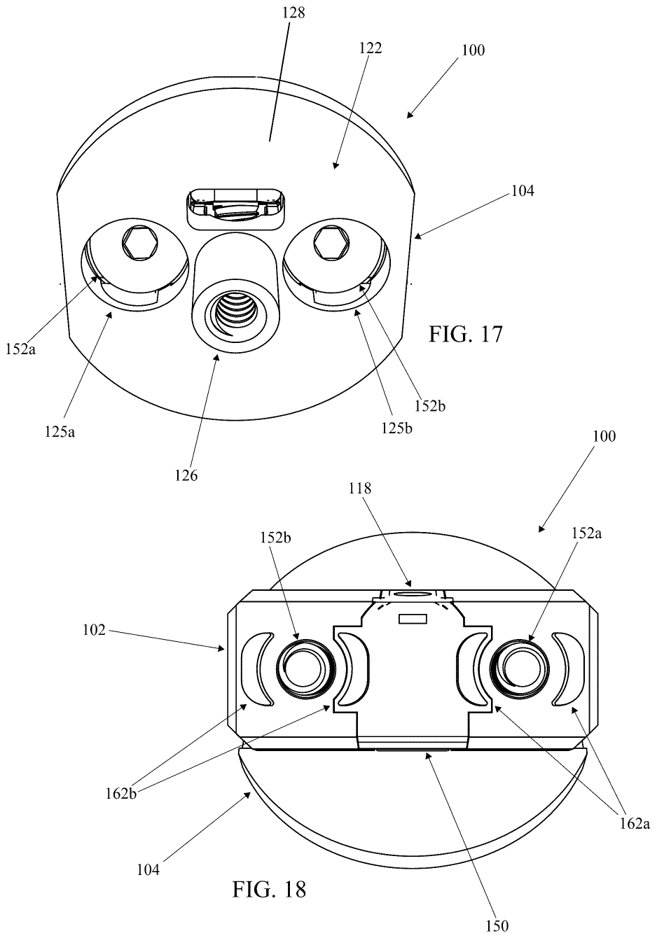

Referring to FIGS. 17 and 18, front and rear elevation views of the hinge mount 100 illustrate the relationship between the first mounting interface 102 and the second mounting interface 104. In FIG. 17, a front elevation view shows the hinge mount 100 showing the second mounting interface 104 with the exterior side 122 and the exterior surface 128 visible. The threaded attachment shaft 126 extends perpendicularly outward from the exterior surface 128. The first connection screw 152a and the second connection screw 152 b are shown through the first screw access port 125a and the second screw access port 125b, respectively.

As further shown in FIG. 18, a rear elevation view shows the first mounting interface 102 with an exterior side exposed. The first connection screw 152a and the second connection screw 152b are exposed through the exterior side. The adjustment access port 118 is visible on the first mounting interface 102. The first mounting interface 102 shows a rear side of the removable screw support bed 150 and features the first pair of curved rail connection fittings 162a and the second pair of curved rail connection fittings 162b, which are configured to interface with a rail mounting system on the helmet 10, may be adapted for connection to an accessory mounting system, or may be adapted for direct connection to a helmet surface.

The hinge mount 100 may be adjusted while the hinge mount 100 is attached to the helmet 10 and a communications device. In some cases, the hinge mount 100 may be adjusted while an entire assembly, including the helmet 10 and the communications device, is worn on the head of a user.

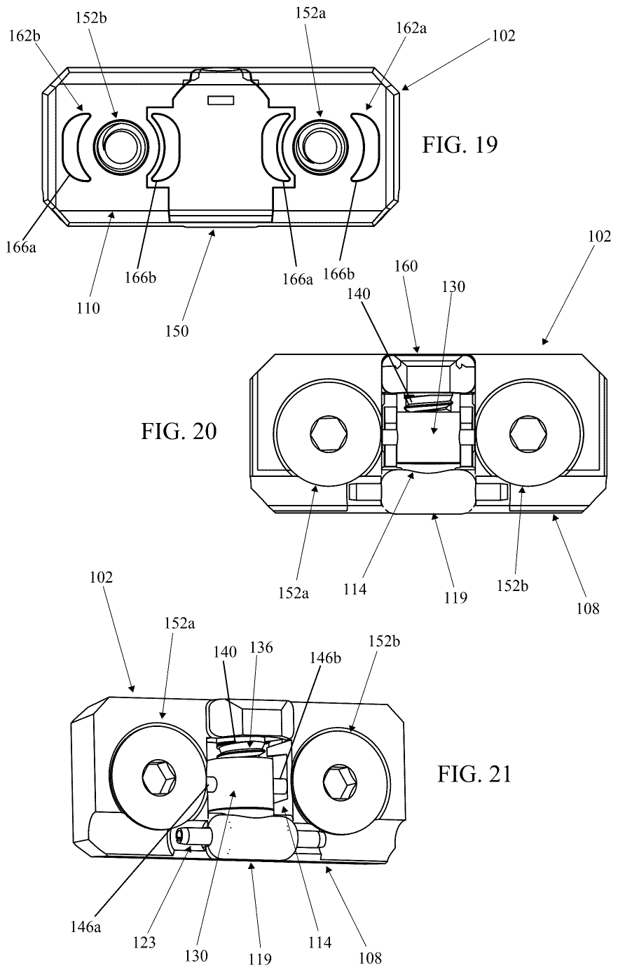

Referring to FIGS. 19-22, the first mounting interface 102 is described in further detail. The first mounting interface 102 includes the interior side 108 and the exterior side 110. The first mounting interface 102 may include a first countersinking screw hole 112a and a second countersinking screw hole 112b positioned on opposing sides of the first mounting interface 102. The first countersinking screw hole 112a and the second countersinking screw hole 112b may be configured to receive the first connection screw 152a and the second connection screw 152b, respectively, for mounting the hinge mount 100 to the rail system 12, to an accessory mounting system, or directly to a side surface of the helmet 10.

With continued reference to FIGS. 19-22, an actuator housing 114 may be positioned within a body of the first mounting interface 102. The actuator housing 114 may be positioned between the first countersinking screw hole 112a and the second countersinking screw hole 112b. The adjustment access port 118 may provide access to the actuator housing 114.

As further shown in FIGS. 19-21, a first mounting interface knuckle 119 may extend from the first mounting interface 102. A pin 123 may be positioned within the first mounting interface knuckle 119 to form an axis of rotation. The pin 123 may extend through the first mounting interface knuckle 119 to provide a pivot axis connection with the second mounting interface 104.

Referring to FIG. 20 and FIG. 21, a linear actuator 130 may be positioned within the actuator housing 114. The linear actuator 130 may include a first lateral engagement member 146a and a second lateral engagement member 146b extending laterally from a body of the linear actuator 130. The first lateral engagement member 146a and the second lateral engagement member 146b may be configured to engage with pivot cams on the second mounting interface 104.

With continued reference to FIG. 20-FIG. 22, the screw 136 may be mounted within the actuator housing 114. The screw 136 may have a body with threads 140. The threads 140 may engage with the linear actuator 130. The screw 136 may have a head with a drive, wherein the drive may be aligned with the adjustment access port 118. Rotation of the screw 136 may cause the linear actuator 130 to move linearly within the actuator housing 114. The linear actuator 130 may have a threaded hole 134 coupled with the screw 136 and a pair of opposing lateral engagement members, wherein rotation of the screw 136 may cause the linear actuator 130 to move linearly within the actuator housing 114.

As further shown in FIGS. 19-21, the first mounting interface 102 may include a first side partial curved rail fitting 166a and a second side partial curved rail fitting 166b. The first side partial curved rail fitting 166a and the second side partial curved rail fitting 166b may form portions of the first pair of curved rail connection fittings 162a and the second pair of curved rail connection fittings 162b. The first side partial curved rail fitting 166a and the second side partial curved rail fitting 166b may be positioned on the removable screw support bed 150, which forms a rear surface of the first mounting interface 102.

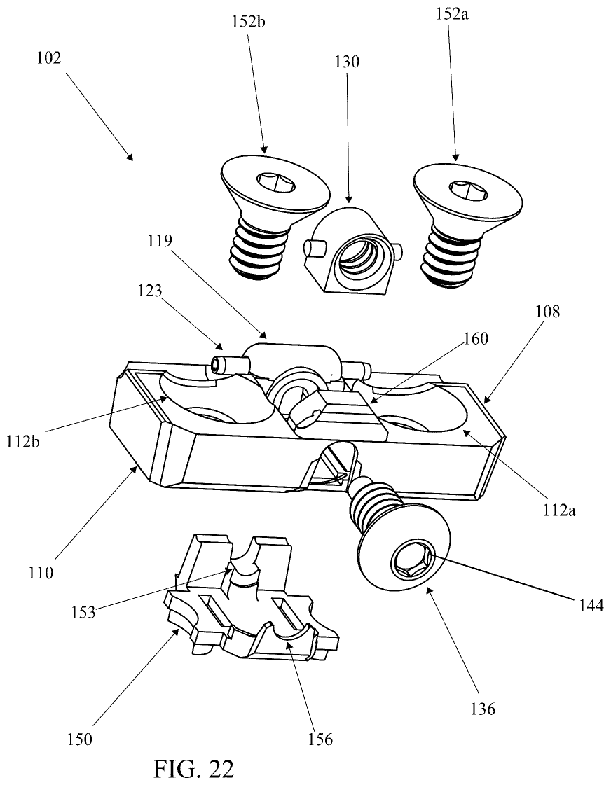

Referring to FIG. 22, an exploded perspective view illustrates the spatial relationship between components of the first mounting interface 102. The first countersinking screw hole 112a and the second countersinking screw hole 112b are positioned on opposing sides of the first mounting interface 102. The first connection screw 152a and the second connection screw 152b are shown above the first mounting interface 102, each featuring threaded bodies for securing the hinge mount 100 to the rail system 12, to an accessory mounting system, or directly to the helmet 10.

With continued reference to FIG. 22, the first mounting interface knuckle 119 extends from the first mounting interface 102 and receives the pin 123. The pin 123 provides the pivot axis for connecting with the second mounting interface 104. The linear actuator 130 is depicted, removed from the first mounting interface 102,. The screw 136 is shown with a drive visible on a head of the screw 136, which provides access for adjustment of an angular position of the hinge mount 100 through the adjustment access port 118. The screw 136 engages with the linear actuator 130 to convert rotational motion into linear movement.

As further shown in FIG. 22, the removable screw support bed 150 is positioned at a rear portion and within the first mounting interface 102. The shaped protrusion 160 extends from the first mounting interface 102 and is configured to engage with the slot 164 on the second mounting interface 104.

The hinge mount 100 may include an adjustment mechanism configured to rotate the second mounting interface 104 relative to the first mounting interface 102 about the pivot axis. The adjustment mechanism may include the screw 136 and the linear actuator 130. Rotation of the screw 136 may cause linear movement of the linear actuator 130 to engage the second mounting interface 104 and impart rotation about the pivot axis. The linear actuator 130 may be positioned within the actuator housing 114 and may move linearly therein responsive to rotation of the screw 136.

The first mounting interface 102 may be configured with different rail interface versions to accommodate various rail mounting systems, with different interface versions to accommodate various accessory mounting systems, or for direct helmet attachment. In some cases, the first mounting interface 102 may be configured to interface with M-LOK rail mounting systems. In some cases, the first mounting interface 102 may be configured to interface with Wing-Loc rail mounting systems. In some cases, the first mounting interface 102 may be configured to interface with accessory mounting systems on a helmet. In some cases, the first mounting interface 102 may be configured for direct attachment to a helmet shell or side surface without requiring a rail mounting system or accessory mounting system. The first pair of curved rail connection fittings 162a and the second pair of curved rail connection fittings 162b may be configured to engage with corresponding features on the rail system 12 of the helmet 10, the first mounting interface 102 may include alternative connection features for interfacing with accessory mounting systems, or the first mounting interface 102 may include alternative connection features for direct helmet attachment.

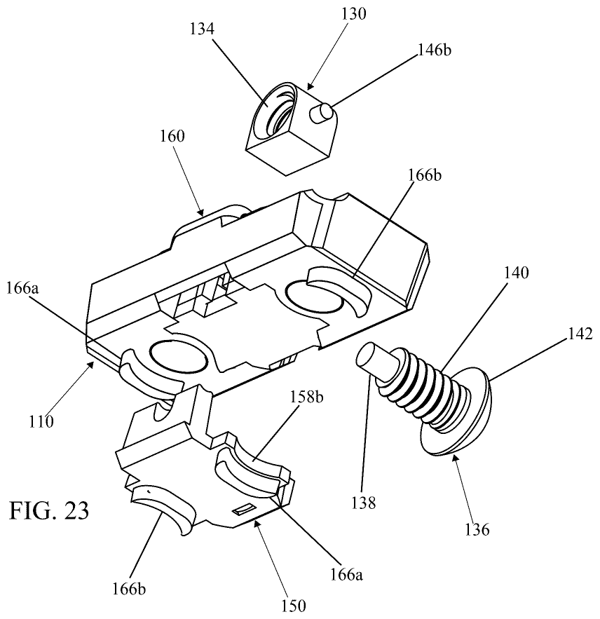

Referring to FIG. 23, the linear actuator 130 is shown in an exploded configuration relative to the first mounting interface 102. The linear actuator 130 includes a threaded hole 134 configured to receive the screw 136. The threaded hole 134 may be positioned within the body of the linear actuator 130 and may be configured to couple with the threads 140 of the screw 136. The linear actuator 130 may be positioned within the actuator housing 114 and may be movable between a closed position and a open, tilted position.

With continued reference to FIG. 23, the screw 136 includes a shank end 138, the threads 140 along a body of the screw 136, and a head 142. The shank end 138 may be positioned at an end of the screw 136 opposite the head 142. The head 142 may include a hex head drive 144 configured to receive a tool for rotating the screw 136. The hex head drive 144 may be aligned with the adjustment access port 118 to provide access for adjustment of an angular position of the hinge mount 100.

As further shown in FIG. 23, the linear actuator 130 includes the second lateral engagement member 146b extending laterally from the body of the linear actuator 130. The linear actuator 130 may have a body providing the threaded hole 134 for coupling with the screw 136 and a pair of opposing lateral engagement members including the first lateral engagement member 146a and the second lateral engagement member 146b. As the screw 136 is caused to rotate via the hex head drive 144, the linear actuator 130 may move linearly within the actuator housing 114.

The removable screw support bed 150 is visible in FIG. 23, featuring a second curved side 158b that defines a portion of a housing geometry. The second curved side 158b may be positioned on a lateral side of the removable screw support bed 150. The removable screw support bed 150 may provide support for the screw 136 during operation of the adjustment mechanism and form part of the rear wall of the first mounting interface 102.

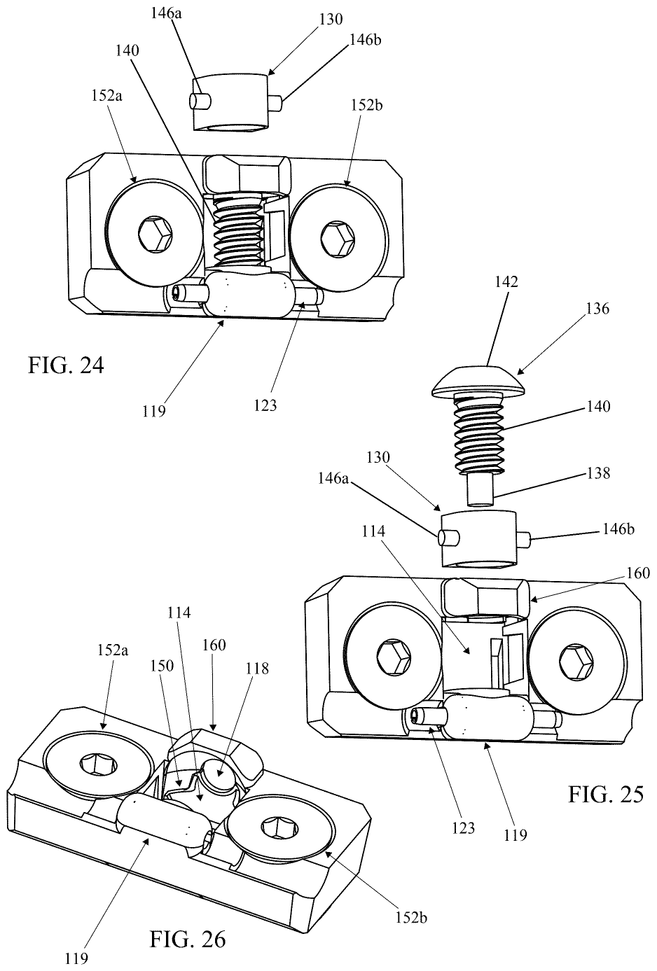

Referring to FIGS. 24, 25, and 26, various views of an interior side of the hinge mount 100 components illustrate the relationship between the first mounting interface 102 and the linear actuator 130 mechanism. In FIG. 24, a front exploded perspective view shows the first mounting interface 102 with the linear actuator 130 shown unassembled from the actuator housing 114. The first connection screw 152a and the second connection screw 152b are visible on opposing sides of the actuator housing 114. The linear actuator 130 includes the first lateral engagement member 146a and the second lateral engagement member 146b extending laterally from the body of the linear actuator 130.

With continued reference to FIG. 25, a perspective view shows the screw 136 and the linear actuator 130 in an exploded configuration relative to the first mounting interface 102. The screw 136 includes the head 142 at one end, the threads 140 along the body of the screw 136, and the shank end 138 at an opposite end. The linear actuator 130 features the first lateral engagement member 146a and the second lateral engagement member 146b positioned on opposing sides. The actuator housing 114 is visible within the first mounting interface 102, configured to receive the linear actuator 130.

As further shown in FIG. 26, a perspective view shows the first mounting interface 102 with the screw 136 and the linear actuator 130 removed from the actuator housing 114. The first mounting interface knuckle 119 is visible with the pin 123 extending through the first mounting interface knuckle 119. The removable screw support bed 150 is fitted in place for providing support to the screw 136. The adjustment access port 118 is visible on the first mounting interface 102.

The screw 136 may move the linear actuator 130 linearly in a direction perpendicular to a pivot axis X defined by the pin 123. As the screw 136 rotates, the threads 140 engage with the threaded hole 134 of the linear actuator 130, converting rotational motion of the screw 136 into linear movement of the linear actuator 130 within the actuator housing 114. The linear movement of the linear actuator 130 in the direction perpendicular to the pivot point may cause the first lateral engagement member 146a and the second lateral engagement member 146b to engage with pivot cams on the second mounting interface 104, thereby imparting rotation of the second mounting interface 104 about the pivot axis.

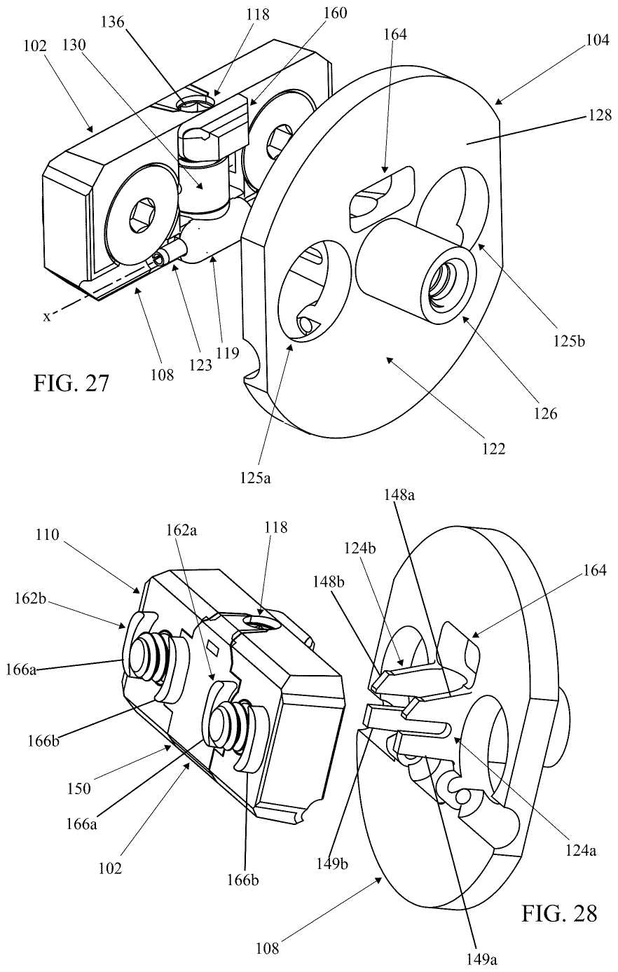

Referring to FIGS. 27 and 28, exploded perspective views illustrate the relationship between the first mounting interface 102 and the second mounting interface 104 along with associated components. The second mounting interface 104 includes an interior side 120 and an exterior side 122. The exterior surface 128 is positioned on the exterior side 122. The threaded attachment shaft 126 extends perpendicularly outward from the exterior surface 128 of the exterior side 122. The first screw access port 125a and the second screw access port 125b are visible on the second mounting interface 104, extending between the interior side 120 and the exterior side 122. The slot 164 is positioned on the second mounting interface 104.

With continued reference to FIG. 27, the first mounting interface 102 is shown from a perspective angle displaying the interior side 108. The adjustment access port 118 is visible on the first mounting interface 102. The first mounting interface knuckle 119 extends from the first mounting interface 102, with the pin 123 positioned within the first mounting interface knuckle 119 to form an axis of rotation. The screw 136 is shown positioned within the first mounting interface 102. The linear actuator 130 is visible within the first mounting interface 102. The shaped protrusion 160 extends from the first mounting interface 102.

As further shown in FIG. 28, the first mounting interface 102 is shown with the exterior side 110 visible, displaying a rear side of the removable screw support bed 150 and the adjustment access port 118. The first pair of curved rail connection fittings 162a and the second pair of curved rail connection fittings 162b are visible, each comprising the first side partial curved rail fitting 166a and the second side partial curved rail fitting 166b.

Referring to FIG. 28, the second mounting interface 104 is shown from a perspective displaying the interior side 120 with a first side pivot cam 124a and a second side pivot cam 124b mounted thereon. The first side pivot cam 124a and the second side pivot cam 124b are mounted on the interior side 120 of the second mounting interface 104. The linear actuator 130 may engage the first side pivot cam 124a and the second side pivot cam 124b to impart rotation of the second mounting interface 104 about the pivot axis.

With continued reference to FIG. 28, the first side pivot cam 124a includes a first side first engagement leg 148a and a first side second engagement leg 149a. The second side pivot cam 124b includes a second side first engagement leg 148b and a second side second engagement leg 149b. The first side first engagement leg 148a and the first side second engagement leg 149a may define a channel therebetween. The second side first engagement leg 148b and the second side second engagement leg 149b may define a channel therebetween. Each of the first side pivot cam 124a and the second side pivot cam 124b may include a pair of parallel engagement legs defining a channel therebetween.

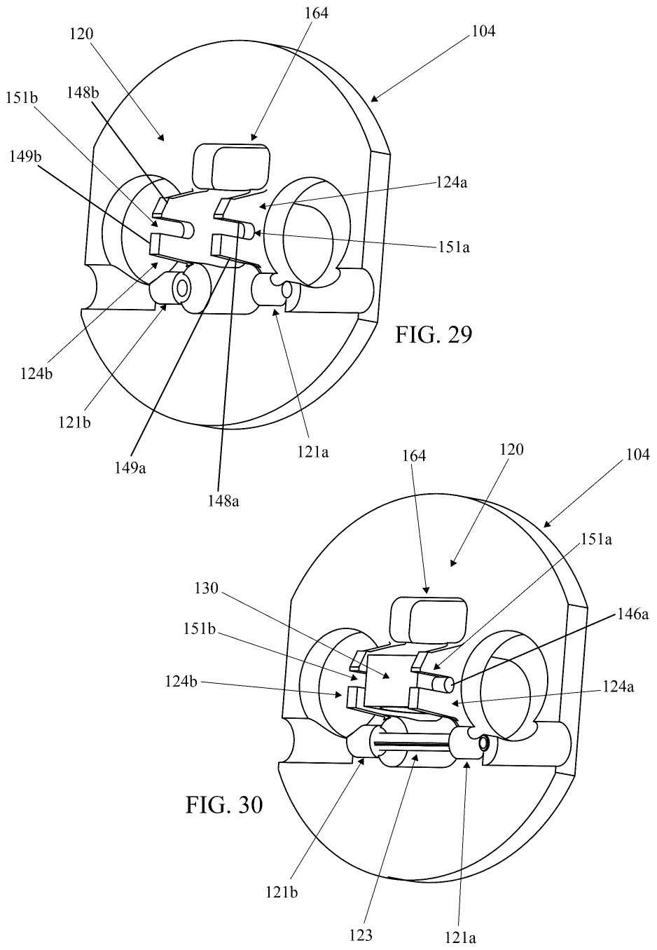

Referring to FIGS. 29 and 30, perspective views of the second mounting interface 104 illustrate the interior side 120 and the pivot cam mechanism with associated components. In FIG. 29, the second mounting interface 104 is shown from a first perspective perspective displaying the interior side 120. A second mounting interface first knuckle 121a and a second mounting interface second knuckle 121b are visible, configured to receive the pin 123 for forming the pivot axis connection with the first mounting interface 102. The hinge 106 may include the first mounting interface knuckle 119 connected to the first mounting interface 102 and the second mounting interface first knuckle 121a and the second mounting interface second knuckle 121b connected to the second mounting interface 104. The pin 123 may extend through the first mounting interface knuckle 119, the second mounting interface first knuckle 121a, and the second mounting interface second knuckle 121b to form the pivot axis.

With continued reference to FIG. 29, the first side pivot cam 124a is mounted on the interior side 120 and includes the first side first engagement leg 148a and the first side second engagement leg 149a, which together form a first side channel 151a configured to receive a lateral engagement member of the linear actuator 130. The second side pivot cam 124b is also mounted on the interior side 120 and includes the second side first engagement leg 148b and the second side second engagement leg 149b, which together form a second side channel 151b. The first side channel 151a may be configured to receive the first lateral engagement member 146a. The second side channel 151b may be configured to receive the second lateral engagement member 146b. The slot 164 is visible on the second mounting interface 104. The first side pivot cam 124a and the second side pivot cam 124b may mirror each other in formation.

As further shown in FIG. 30, the second mounting interface 104 is shown from a second perspective perspective displaying the interior side 120 from a different angle. The linear actuator 130 is shown positioned between the first side pivot cam 124a and the second side pivot cam 124b. The first lateral engagement member 146a of the linear actuator 130 is visible engaging with the first side channel 151a formed between the first side first engagement leg 148a and the first side second engagement leg 149a of the first side pivot cam 124a. The second side channel 151b is visible on the second side pivot cam 124b. The first lateral engagement member 146a may be received within the first side channel 151a of the first side pivot cam 124a and the second lateral engagement member 146b may be received within the second side channel 151b of the second side pivot cam 124b.

The linear actuator 130 may include the first lateral engagement member 146a and the second lateral engagement member 146b, with the first lateral engagement member 146a engaging the first side pivot cam 124a and the second lateral engagement member 146b engaging the second side pivot cam 124b. The first lateral engagement member 146a and the second lateral engagement member 146b may engage the first side pivot cam 124a and the second side pivot cam 124b to push or pull the first side pivot cam 124a and the second side pivot cam 124b relative to the first mounting interface 102, thereby rotating the second mounting interface 104 relative to the first mounting interface 102 about the pivot axis.

The second mounting interface 104 may be adapted to interface with different communications device manufacturers'proprietary pivot mechanisms. In some cases, the second mounting interface 104 may be configured with different attachment shaft configurations or geometries to match pivot mechanisms developed by various communications device manufacturers.

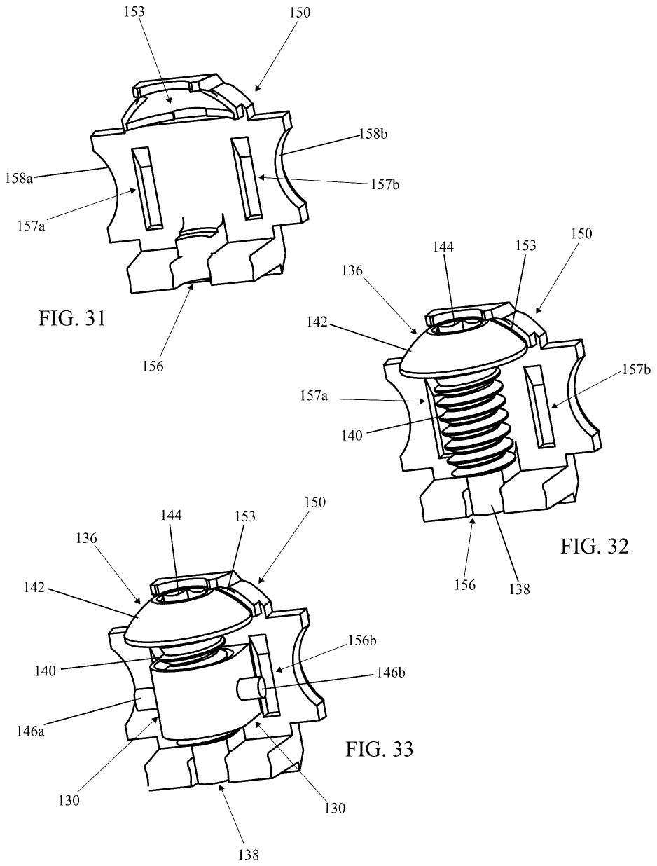

Referring to FIGS. 31-33, the removable screw support bed 150 is described in further detail. The removable screw support bed 150 may be positioned within the first mounting interface 102 and may provide support for the screw 136 during operation of the adjustment mechanism. The removable screw support bed 150 may include a screw head seat 153 configured to receive the head 142 of the screw 136. The screw head seat 153 may be positioned at an upper portion of the removable screw support bed 150 and may cradle the head 142 of the screw 136.

With continued reference to FIGS. 31-33, the removable screw support bed 150 may include a shank end seat 156 configured to support the shank end 138 of the screw 136. The shank end seat 156 may be positioned at a lower portion of the removable screw support bed 150, opposite the screw head seat 153. The screw head seat 153 and the shank end seat 156 may cooperate to support the screw 136 within the first mounting interface 102, maintaining alignment of the screw 136 within the actuator housing 114.

As further shown in FIGS. 31-33, the removable screw support bed 150 may include a first slot 157a and a second slot 157b positioned on opposing sides of the removable screw support bed 150. The first slot 157a and the second slot 157b may extend partially through a body of the removable screw support bed 150 to accommodate engagement with the first side pivot cam 124a and the second side pivot cam 124b, including the first side first engagement leg 148a, the second side first engagement leg 148b, the first side second engagement leg 149a, and the second side second engagement leg 149b.

Referring to FIG. 31, the removable screw support bed 150 may include a first curved side 158a and the second curved side 158b defining curved geometry of the removable screw support bed 150 on opposing lateral sides. The first curved side 158a and the second curved side 158b may define a profile of the removable screw support bed 150 that corresponds to an interior geometry of the first mounting interface 102.

With continued reference to FIGS. 32 and 33, the screw 136 is shown assembled within the removable screw support bed 150 along with the linear actuator 130. The screw 136 includes the head 142 with the hex head drive 144 positioned at a top portion, the threads 140 along the body of the screw 136, and the shank end 138 at an opposite end. The screw head seat 153 is shown cradling the head 142 of the screw 136. The shank end seat 156 supports the shank end 138 of the screw 136.

As further shown in FIG. 33, the linear actuator 130 is positioned within the removable screw support bed 150, with the first lateral engagement member 146a and the second lateral engagement member 146b extending laterally. The first lateral engagement member 146a and the second lateral engagement member 146b may be cylindrical in shape. The cylindrical shape of the first lateral engagement member 146a and the second lateral engagement member 146b may facilitate engagement with the first side channel 151a and the second side channel 151b of the first side pivot cam 124a and the second side pivot cam 124b, respectively.

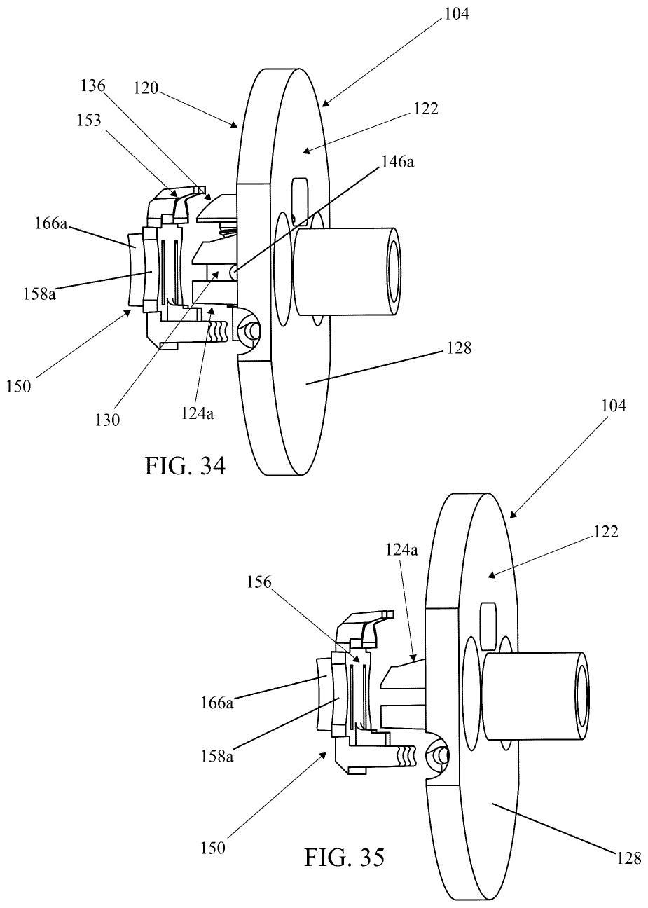

Referring to FIGS. 34 and 35, perspective exploded views illustrate the relationship between the second mounting interface 104 and the removable screw support bed 150 and associated components. In FIG. 34, the second mounting interface 104 is shown from a first perspective perspective displaying both the interior side 120 and the exterior side 122. The exterior surface 128 is visible on the exterior side 122. The threaded attachment shaft 126 may extend perpendicularly outward from the exterior surface 128 of the second mounting interface 104. The threaded attachment shaft 126 may be configured to connect with an attachment device such as a communications headset or hearing protection device.

With continued reference to FIG. 34, the first side pivot cam 124a is mounted on the interior side 120 of the second mounting interface 104. The linear actuator 130 is shown with the first lateral engagement member 146a engaging with the first side pivot cam 124a. The removable screw support bed 150 is visible, featuring the shank end seat 156 and the first curved side 158a. The first side partial curved rail fitting 166a is shown on the removable screw support bed 150. The screw 136 is shown extending within the linear actuator 130 and between the first side pivot cam 124a and the second side pivot cam 124b.

As further shown in FIG. 35, the second mounting interface 104 is shown from a second perspective perspective displaying the interior side 120 and the exterior side 122 from a different angle. The exterior surface 128 is visible on the exterior side 122. The first side pivot cam 124a is mounted on the interior side 120. The removable screw support bed 150 is shown positioned relative to the second mounting interface 104.

The first mounting interface 102 may include the removable screw support bed 150 positioned within the first mounting interface 102. The removable screw support bed 150 may include the screw head seat 153 configured to receive the head 142 of the screw 136 and the shank end seat 156 configured to support the shank end 138 of the screw 136. An exterior side of the removable screw support bed 150 may provide a flush, continuous rear wall of the first mounting interface 102.

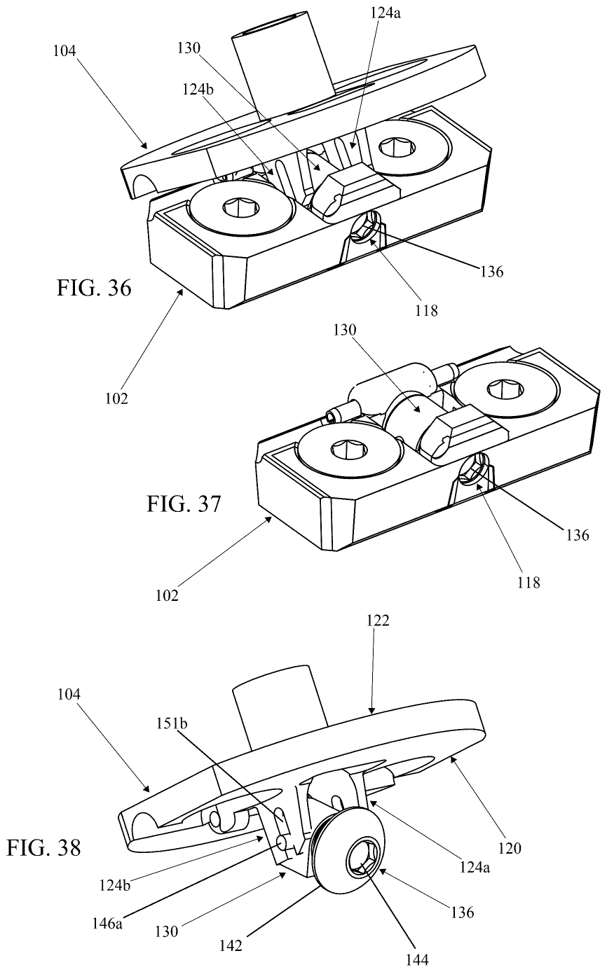

Referring to FIGS. 36-38, the operation and interaction of components of the hinge mount 100 are described. As the screw 136 is rotated via the hex head drive 144, the linear actuator 130 moves linearly within the actuator housing 114. The linear movement of the linear actuator 130 causes the first lateral engagement member 146a and the second lateral engagement member 146b to engage the first side pivot cam 124a and the second side pivot cam 124b, respectively. The engagement of the first lateral engagement member 146a and the second lateral engagement member 146b with the first side pivot cam 124a and the second side pivot cam 124b may push or pull the first side pivot cam 124a and the second side pivot cam 124b relative to the first mounting interface 102, thereby rotating the second mounting interface 104 relative to the first mounting interface 102 about the pivot axis.

With continued reference to FIGS. 36-38, the first side pivot cam 124a and the second side pivot cam 124b function as dual opposed camming arms that engage with both sides of the linear actuator 130. The first lateral engagement member 146a engages with the first side channel 151a of the first side pivot cam 124a, and the second lateral engagement member 146b engages with the second side channel 151b of the second side pivot cam 124b. The engagement of the first lateral engagement member 146a and the second lateral engagement member 146b within the respective channels of the first side pivot cam 124a and the second side pivot cam 124b may occur during extension of the hinge mount 100, during retraction of the hinge mount 100, and while the hinge mount 100 is at rest.

As further shown in FIGS. 36-38, the dual opposed configuration of the first side pivot cam 124a and the second side pivot cam 124b engaging with the first lateral engagement member 146a and the second lateral engagement member 146b on both sides of the linear actuator 130 may prevent the second mounting interface 104 from moving independently of the linear actuator 130 at any time. The engagement of the first lateral engagement member 146a within the first side channel 151a and the second lateral engagement member 146b within the second side channel 151b may prevent movement of the second mounting interface 104 under load in either direction. The first side first engagement leg 148a and the first side second engagement leg 149a of the first side pivot cam 124a, together with the second side first engagement leg 148b and the second side second engagement leg 149b of the second side pivot cam 124b, may constrain the first lateral engagement member 146a and the second lateral engagement member 146b within the respective channels, thereby maintaining the angular position of the second mounting interface 104 relative to the first mounting interface 102 regardless of external forces applied to the hinge mount 100 or an attached device.

The hinge mount 100 may be utilized in various operational environments, including where helmet-mounted communications devices or hearing protection are employed. In some cases, the hinge mount 100 may be used in military applications where personnel wear tactical helmets equipped with rail systems for extended periods. In some cases, the hinge mount 100 may be used in law enforcement applications where officers require communications headsets mounted to protective helmets. In some cases, the hinge mount 100 may be used in industrial or aviation settings where hearing protection is mounted to safety helmets.

The adjustment mechanism of the hinge mount 100 may allow a user to customize the angular position of an attached communications device or hearing protection relative to the helmet 10. The user may rotate the screw 136 via the hex head drive 144 through the adjustment access port 118 to achieve a desired angular position of the second mounting interface 104 relative to the first mounting interface 102. The infinitely adjustable nature of the adjustment mechanism may allow the user to position the attached device at any angle within the range of rotation provided by the hinge 106.

In some aspects, the hinge mount 100 may improve the seal of hearing protection against the wearer's head by allowing adjustment of the angle at which ear cups contact the head. In some cases, the hinge mount 100 may reduce pressure points caused by misaligned hearing protection or communications devices. In some cases, the hinge mount 100 may accommodate variations in head shape, helmet fit, or rail mounting angle that would otherwise result in suboptimal positioning of attached devices.

The hinge mount 100 may be adjusted in the field without requiring disassembly of the helmet or communications device. A user may access the hex head drive 144 through the adjustment access port 118 using a standard hex key or similar tool. The adjustment may be performed while the helmet 10 is worn, allowing the user to make real-time adjustments based on comfort and fit. In some cases, the adjustment may be performed by the wearer or by another individual assisting the wearer.

The dual opposed pivot cam configuration may provide resistance to unintended angular movement of the second mounting interface 104 during use. External forces applied to an attached communications device or hearing protection, such as forces resulting from contact with equipment, vehicle interiors, or other objects, may be resisted by the engagement of the first lateral engagement member 146a and the second lateral engagement member 146b within the respective channels of the first side pivot cam 124a and the second side pivot cam 124b. The angular position set by the user may be maintained throughout operational use without requiring readjustment.

A number of implementations have been described. Nevertheless, it will be understood that various modifications may be made without departing from the spirit and scope of the disclosure. Accordingly, other implementations are within the scope of the following claims.

1. An adjustable hinge mount for positioning an attachment device on a helmet, the mount comprising:
a first mounting interface configured to connect with the helmet;
a second mounting interface configured to connect with the attachment device;
a hinge connecting the first mounting interface with the second mounting interface and providing a pivot axis therebetween; and
an adjustment mechanism configured to rotate the second mounting interface relative to the first mounting interface about the pivot axis, the adjustment mechanism including a screw and a linear actuator, wherein rotation of the screw causes linear movement of the linear actuator to engage the second mounting interface and impart rotation about the pivot axis.

2. The adjustable hinge mount of claim 1, wherein the second mounting interface includes a first pivot cam and a second pivot cam, and wherein the linear actuator engages the first pivot cam and the second pivot cam to impart rotation of the second mounting interface about the pivot axis.

3. The adjustable hinge mount of claim 2, wherein the linear actuator includes a first lateral engagement member and a second lateral engagement member, the first lateral engagement member engaging the first pivot cam and the second lateral engagement member engaging the second pivot cam.

4. The adjustable hinge mount of claim 3, wherein each of the first pivot cam and the second pivot cam includes a pair of parallel engagement legs defining a channel therebetween, and wherein the first lateral engagement member is received within the channel of the first pivot cam and the second lateral engagement member is received within the channel of the second pivot cam.

5. The adjustable hinge mount of claim 1, wherein the first mounting interface includes an actuator housing positioned within a body of the first mounting interface, and wherein the linear actuator is positioned within the actuator housing and moves linearly therein responsive to rotation of the screw.

6. The adjustable hinge mount of claim 5, wherein the first mounting interface includes an adjustment access port providing access to the actuator housing, and wherein a head of the screw includes a drive aligned with the adjustment access port.

7. The adjustable hinge mount of claim 1, wherein the hinge provides rotation of the second mounting interface relative to the first mounting interface through a range of 0 degrees to 30 degrees.

8. The adjustable hinge mount of claim 1, wherein the second mounting interface includes a threaded attachment shaft extending perpendicularly outward from an exterior surface of the second mounting interface, the threaded attachment shaft configured to connect with the attachment device.

9. The adjustable hinge mount of claim 1, wherein the first mounting interface includes curved rail connection fittings configured to interface with a rail mounting system.

10. An adjustable hinge mount for positioning an attachment device on a helmet, the mount comprising:
a first mounting interface configured to connect to the helmet, the first mounting interface including an actuator housing and an adjustment access port providing access to the actuator housing;
a second mounting interface configured to connect with the attachment device, the second mounting interface including a first pivot cam and a second pivot cam mounted on an interior side thereof;
a hinge connecting the first mounting interface with the second mounting interface and providing a pivot axis allowing angular adjustment between the first mounting interface and the second mounting interface;
a screw mounted within the actuator housing, the screw having a body with threads and a head with a drive aligned with the adjustment access port; and
a linear actuator positioned within the actuator housing and having a threaded hole coupled with the screw and a pair of opposing lateral engagement members, wherein rotation of the screw causes the linear actuator to move linearly within the actuator housing, the lateral engagement members engaging the first and second pivot cams to rotate the second mounting interface relative to the first mounting interface about the pivot axis.

11. The adjustable hinge mount of claim 10, wherein each of the first pivot cam and the second pivot cam includes a first engagement leg and a second engagement leg defining a channel therebetween, and wherein the lateral engagement members are received within the channels of the first and second pivot cams.

12. The adjustable hinge mount of claim 11, wherein the lateral engagement members are cylindrical in shape.

13. The adjustable hinge mount of claim 10, wherein the first mounting interface includes a screw support bed positioned within the first mounting interface, the screw support bed including a screw head seat configured to receive the head of the screw and a shank end seat configured to support a shank end of the screw.

14. The adjustable hinge mount of claim 10, wherein the hinge includes a first mounting interface knuckle connected to the first mounting interface and a first knuckle and a second knuckle connected to the second mounting interface, and wherein a pin extends through the first mounting interface knuckle, the first knuckle, and the second knuckle to form the pivot axis.

15. The adjustable hinge mount of claim 10, wherein the second mounting interface includes a threaded attachment shaft extending perpendicularly outward from an exterior surface of the second mounting interface, the threaded attachment shaft configured to connect with the attachment device.

16. The adjustable hinge mount of claim 15, wherein the second mounting interface includes a first screw access port and a second screw access port extending between an interior side and an exterior side of the second mounting interface, the first screw access port and the second screw access port providing access for connection screws to attach the first mounting interface to the helmet or a mounting system attached to the helmet.

17. An adjustable hinge mount for positioning an attachment device on a helmet, the mount comprising:
a first mounting interface configured to connect with a helmet mounting system, the first mounting interface including an interior side and an exterior side, a first countersinking screw hole and a second countersinking screw hole for mounting connection screws, an actuator housing positioned within a body of the first mounting interface and between the first and second countersinking screw holes, and an adjustment access port for providing access to the actuator housing;
a second mounting interface configured to connect with the attachment device, the second mounting interface including an interior side and an exterior side, a first pivot cam and a second pivot cam mounted on the interior side, a first screw access port and a second screw access port extending between the interior side and the exterior side, and a threaded attachment shaft extending perpendicularly outward from an exterior surface of the exterior side;
a hinge providing a pivot axis connecting the first mounting interface with the second mounting interface, the hinge allowing up to 30 degrees or more of rotation between respective interface planes of the first mounting interface and the second mounting interface;
a screw mounted within the actuator housing, the screw having a body with threads, a head with a drive, wherein the drive is aligned with the adjustment access port; and
a linear actuator positioned within the actuator housing and movable between a closed position and an open position, the linear actuator having a body providing a threaded hole for coupling with the screw and a pair of opposing lateral engagement members, wherein as the screw is caused to rotate via the drive, the linear actuator moves linearly within the actuator housing, the lateral engagement members engaging the first and second pivot cams to push or pull the first and second pivot cams relative to the first mounting interface, thereby rotating the second mounting interface relative to the first mounting interface about the pivot axis.

18. The adjustable hinge mount of claim 17, wherein each of the first pivot cam and the second pivot cam includes a first engagement leg and a second engagement leg defining a channel therebetween, and wherein the lateral engagement members are received within the channels of the first and second pivot cams.

19. The adjustable hinge mount of claim 18, wherein the lateral engagement members are cylindrical in shape.

20. The adjustable hinge mount of claim 17, wherein the first mounting interface includes a screw support bed positioned within the first mounting interface, the screw support bed including a screw head seat configured to receive the head of the screw and a shank end seat configured to support a shank end of the screw.
